(19) United States
(12) Patent Application Publication
(10) Pub. No.: US 2013/0107516 A1
(43) Pub. Date: May 2, 2013

(54) HIGH-EFFICIENCY LIGHT-EMITTING DIODE LAMP

(71) Applicant: Chih-Shen Chou, Taipei (TW)

(72) Inventor: Chih-Shen Chou, Taipei (TW)

(21) Appl. No.: 13/282,725

(22) Filed: Oct. 27, 2011

(51) Int. Cl. F21V 7/00; F21V 29/00

(52) U.S. Cl. 362/235

(57) ABSTRACT

A high-efficiency LED lamp has an LED board and a light guide mounted inside a lamp holder. The lamp holder has a cover mounted on a top thereof and a base securely mounted on a bottom thereof and electrically connected to the LED board. The lamp holder is made from ceramic or aluminum oxide ceramic through a high-temperature sintering process and is porous to provide enhanced heat-dissipating effects. The light guide is a transparent glass cylinder made from borosilicate, with a bottom thereof facing LEDs mounted on the LED board, and a reflection layer is coated on a top thereof. The reflection layer has a conical reflection mirror facing the LEDs. Accordingly, the LEDs irradiate light to the light guide and the light is reflected by the reflection mirror to emit through entire cylindrical periphery of the light guide and significantly enhance luminance efficiency.

### BACKGROUND OF THE INVENTION

1. Field of the Invention

The present invention relates to a light-emitting diode (LED) lamp, and more particularly to an LED lamp having enhanced heat-dissipating characteristics and luminance efficiency.

2. Description of the Related Art

Due to low power consumption and high durability, various types of single-color and multi-color LEDs have come on the scene in recent years. LEDs have undoubtedly become the major light sources of eco-friendly lamps, especially after white LEDs were launched in the market. To satisfy lighting needs, high-power and high-luminance LEDs have already been applied to all sorts of lamps. However, high-power LEDs inevitably introduce heat dissipation problem. In other words, lamps equipped with high-power LEDs must have good heat dissipation approach to ensure normal operation of the LEDs. For instance, housings of many LED lamps in the market have multiple heat-dissipating fins formed thereon, and the fins serve to dissipate high heat generated by LEDs in operation. Hence, light bulbs using LEDs as light source not only significantly differ from conventional light bulbs in appearance but also are more complicated structurally.

Furthermore, a conventional incandescent light bulb can illuminate in all directions through a ball-shaped glass shell thereof while each LED employed by the LED lamps can only illuminate in limited range of directions, failing to be an omnidirectional light source. To tackle the issue, more LEDs are required to orient in different directions so as to provide a wide-angle lighting. However, the complexity and production cost of LED lamps are inevitably escalated.

As far as power supply is concerned, conventional LED lamps employ transformers to convert inputted AC power into DC power and supply the DC power to LEDs. Under the circumstance, besides the power loss arising from the AC to DC conversion, the use of transformer leads to bulky and costly LED lamps.

### SUMMARY OF THE INVENTION

An objective of the present invention is to provide a high-efficiency LED lamp possessing heat-dissipating nature by structurally modifying a lamp holder and enhancing luminance efficiency with wide angle lighting design.

To achieve the foregoing objective, the high-efficiency light-emitting diode (LED) lamp has a lamp holder, an LED board, a light guide, a cover and a base.

The lamp holder is hollow, conical and porous, and has an upper opening and a lower opening.

The LED board is mounted in the lamp holder, is adjacent to the upper opening, and has a circuit board, at least one LED and a power supply circuit. The at least one LED is mounted on a surface of the circuit board. The power supply circuit is formed on the circuit board and has an input terminal and an output terminal. The output terminal is connected to the at least one LED.

The light guide is mounted on the LED board, is a transparent glass cylinder and has a top end, a bottom end, an LED chamber, a pit and a reflection layer. The LED chamber is formed in the bottom end of the light guide to align with the at least one LED on the LED board. The pit is formed in the top end of the light guide. The reflection layer is coated on an inner wall of the pit to form a conical reflection mirror on a bottom of the reflection layer, and aligns with the at least one LED on the LED board.

The cover is transparent, has an open bottom end, and corresponds to and is mounted on the upper opening of the lamp holder.

The base is mounted on the lower opening of the lamp holder and electrically connected to the input terminal of the power supply circuit on the LED board.

Due to the porous structure, the lamp holder possesses air permissibility. Therefore, heat generated by operating LEDs can be dissipated out through the pores of the lamp holder to facilitate heat dissipation. Under the circumstance, enhanced heat dissipation can be achieved without requiring additional heat dissipation device. The lamp holder has a light guide therein having a special optical design. The light guide is composed of a transparent glass cylinder. When the at least one LED on the LED board emits light through the bottom end of the light guide, the direct light illuminates the entire cylindrical periphery of the light guide and the reflection layer of the pit. The light reflected by the reflection layer further effectively enhances the luminance efficiency of the light guide and of the LED lamp.

Preferably, the power supply circuit formed on the LED board is an AC power supply circuit having a voltage dependent resistor (VDR), a thermistor, multiple resistors and a fuse. One end of the VDR is connected to the base for inputting AC power. One end of the thermistor is connected to the at least one LED on the LED board, and each one of the at least one LED is an AC LED. The resistors and the fuse are serially connected between the VDR and the thermistor.

The AC power supply circuit can directly receive power from the AC mains to activate the LEDs without using a transformer. Additionally, the LED lamp without a transformer can be more compact in size, the VDR has input voltage protection, and the thermistor provides overheat protection.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a high-efficiency LED lamp in accordance with the present invention;

FIG. 2 is an exploded perspective view of the high-efficiency LED lamp in FIG. 1;

FIG. 3 is a side view in partial section of the high-efficiency LED lamp in FIG. 1; and

FIG. 4 is a circuit diagram of a power supply circuit of the high-efficiency LED lamp in FIG. 1.

### DETAILED DESCRIPTION OF THE INVENTION

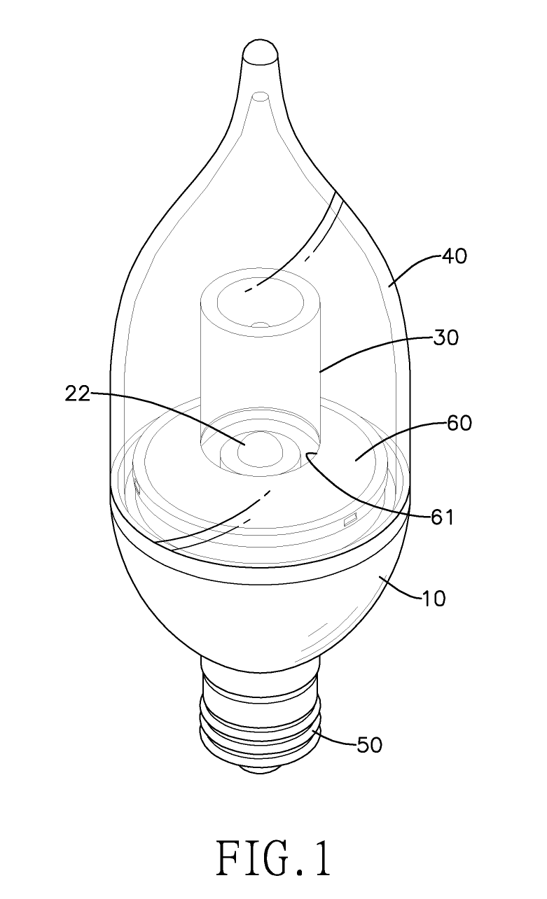

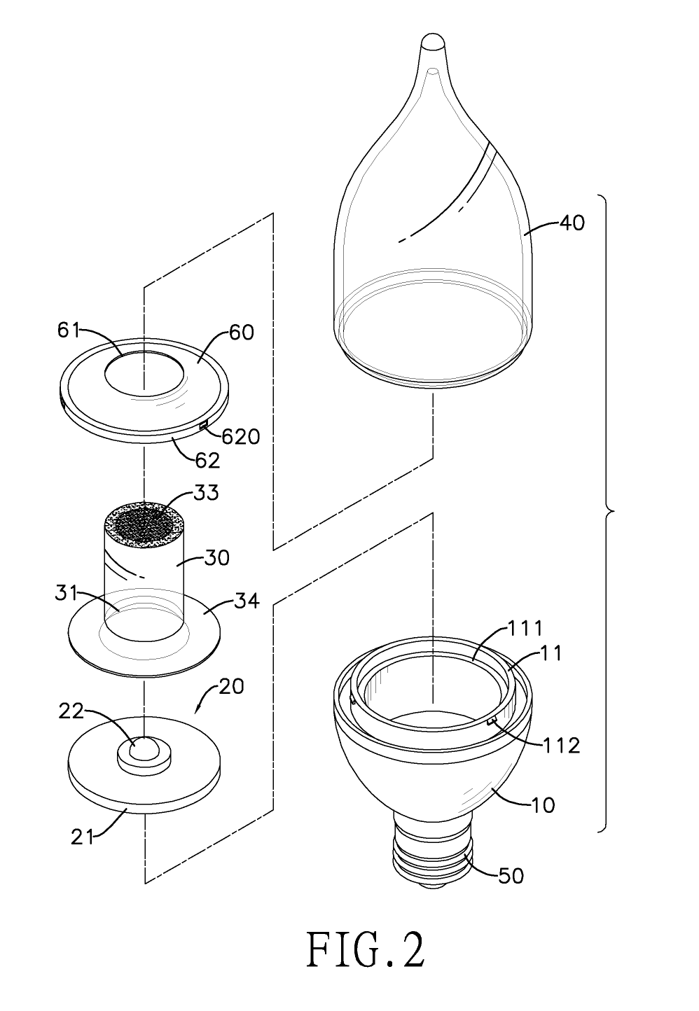

With reference to FIGS. 1 and 2, a high efficiency LED lamp in accordance with the present invention has a lamp holder 10, an LED board 20, a light guide 30, a cover 40 and a base 50. In the present embodiment, the high-efficiency LED lamp further has a fixing disc 60 for the LED board 20 and the light guide 30 to be securely mounted therein.

The lamp holder 10 is hollow and conical, is made from ceramic or aluminum oxide ceramic through a high-temperature sintering process, and is porous. In the present embodiment, the lamp holder 10 has an outer diameter being largest at a top and progressively decreasing from the top downwardly. The lamp holder 10 further has an upper opening, a lower opening and an annular portion 11. The upper opening and the lower opening are respectively formed through the top and the bottom of the lamp holder 10. The annular portion 11 is formed on an inner wall of the lamp holder 10 and protrudes upwardly from the upper opening of the lamp holder 10, and has an annular recess 111 and at least one locking lug 112. The annular recess 111 is downwardly formed in an inner wall of the annular portion 11. The at least one locking lug 112 is formed on and protrudes radially from a periphery of the annular portion 11. In the present embodiment, the annular portion 11 has multiple locking lugs 112 formed on the periphery of the annular portion 11 and is collaborated with the fixing disc 60 to fix the LED board 20 and the light guide 30.

The LED board 20 is mounted in the annular portion 11 of the lamp holder 10 and is mounted on the annular recess 111. In the present embodiment, the LED board 20 has a circuit board 21, at least one LED 22 and a power supply circuit. The at least one LED 22 is mounted on a surface of the circuit board 21. The power supply circuit is formed on the circuit board 21 and is connected to the base 50 and the at least one LED 22 to supply power thereto. The details of the power supply circuit are described later.

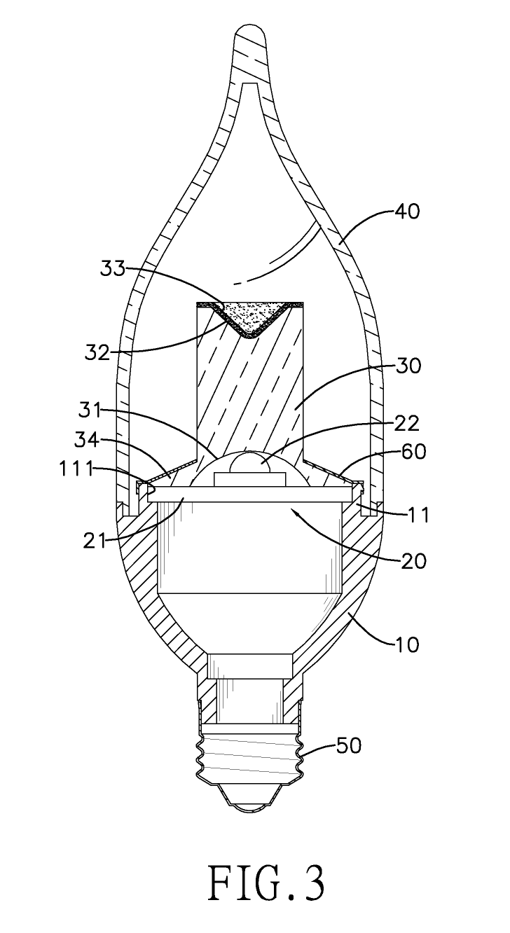

With reference to FIGS. 2 and 3, the light guide is perpendicularly mounted on the LED board 20. In the present embodiment, the light guide 30 is a solid glass cylinder made from borosilicate and is highly transparent. The light guide 30 has a top end, a bottom end, a flange 34, an LED chamber 31, a pit 32 and a reflection layer 33. The flange 34 is formed on and protrudes radially from a perimeter of the bottom end of the light guide 30 to enlarge a basal area of the light guide 30 so that the light guide 30 can be firmly mounted on the LED board 20. The LED chamber 31 is dome-shaped and centrally formed in the bottom end of the light guide 30 to align with the at least one LED 22 on the LED board 20 for the at least one LED 22 to be accommodated in the LED chamber 31. The pit 32 is conically formed in the top end of the light guide 30. The reflection layer 33 is coated on an inner wall of the pit 32 with sputtering aluminum to serve as a conical reflection mirror, and aligns with the at least one LED 22 on the LED board 20. When the at least one LED 22 emits light, light beams are directly irradiated on the light guide 30 through the LED chamber so that the entire cylindrical periphery of the light guide 30 is illuminated. The direct light irradiated by the at least one LED 22 is further reflected by the reflection layer 33 due to an effect of reflection mirror to further increase the luminance efficiency.

The fixing disc 60 takes the form of a shallow disc and has a through hole 61 and a ring wall 62. The through hole 61 is centrally formed through the fixing disc 60. The diameter of the through hole 61 matches an outer diameter of the cylindrical portion of the light guide 30 and is less than an outer diameter of the flange 34 of the light guide 30 so that the cylindrical portion of the light guide 30 can penetrate through the through hole 61 of the fixing disc 60 while the flange 34 of the light guide 30 is blocked and held by the fixing disc 60. The ring wall 62 has an inner diameter matching an outer diameter of the annular portion 11 of the lamp holder 10, and has at least one notch 620 formed in a periphery thereof and corresponding to and engaging the respective locking lug 112 on the periphery of the annular portion 11 for the fixing disc 60 to fix the LED board 20 and the light guide 30 inside the lamp holder 10.

The cover 40 is transparent, has an open bottom end, and corresponding to and mounted on the upper opening of the lamp holder 10.

The base 50 is mounted on the lower opening of the lamp holder 10 and is electrically connected to the power supply circuit mounted on the LED board 20. In the present embodiment, the base 50 is a threaded base capable of being screwed into a socket for conventional light bulbs to acquire power for operating the at least one LED 22 on the LED board 20.

As the lamp holder 10 is made from ceramic or aluminum oxide ceramic through a high-temperature sintering process, the LED lamp possesses good air permissibility due to a lot of fine pores formed through the lamp holder 10 so that the LED lamp has enhanced heat-dissipating effect and luminance efficiency. Hence, the heat generated by operating the at least one LED 22 on the LED board 20 can be dissipated out through the fine pores of the lamp holder 10 to effectively reduce the temperature inside the lamp holder 10 so as to let the at least one LED 22 on the LED board 20 be operated normally. Given the heat dissipation approach, the lamp holder 10 requires no additional heat dissipation device.

To upgrade the luminance efficiency, the light guide 30 having a special optical design is mounted on the LED board 20. As the light guide 30 is formed by a glass cylinder with high transparency, when the at least one LED 22 on the LED board 20 emits light through the bottom end of the light guide 30, the direct light illuminates the entire cylindrical periphery of the light guide 30 and the reflection layer 33 of the pit 32. The light reflected by the reflection layer 33 further effectively enhances the luminance efficiency of the light guide 30 and of the LED lamp.

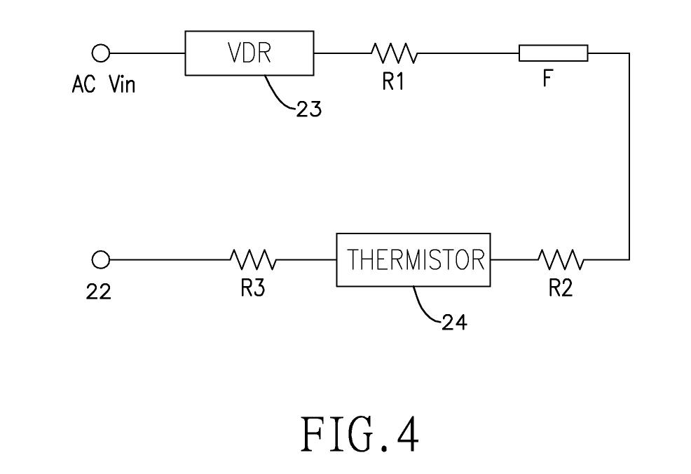

With reference to FIG. 4, a power supply circuit formed on the LED board 20 is an AC power supply circuit having a voltage dependent resistor (VDR) 23, a thermistor 24, multiple resistors R1˜R2 and a fuse F. One end of the VDR 23 is connected to the base 50 for inputting AC power. One end of the thermistor 24 is connected to the at least one LED 22 on the LED board 20, and each one of the at least one LED 22 is an AC LED. The resistors R1˜R2 and the fuse F are serially connected between the VDR 23 and the thermistor 24. Given the foregoing AC power supply circuit and the AC LED, the LED lamp can be driven by using power from the AC mains. The VDR 23 provides protection against input voltage. When large voltage is inputted, the resistance of the VDR 23 is lowered and the large voltage passes through the VDR 23 and breaks the fuse F as a protection means to stabilize voltage in a specification range, thereby avoiding element burnout in the circuit arising from over-voltage or unstable voltage. The thermistor 24 targets at providing overheat protection against burnout of the at least one LED 22 due to a high temperature on the LED board 20.

Even though numerous characteristics and advantages of the present invention have been set forth in the foregoing description, together with details of the structure and function of the invention, the disclosure is illustrative only.

Changes may be made in detail, especially in matters of shape, size, and arrangement of parts within the principles of the invention to the full extent indicated by the broad general meaning of the terms in which the appended claims are expressed.

What is claimed is:

1. A high-efficiency light-emitting diode (LED) lamp comprising:
a lamp holder being hollow, conical and porous, and having an upper opening and a lower opening;
an LED board mounted in the lamp holder, being adjacent to the upper opening and having:
a circuit board;
at least one LED mounted on a surface of the circuit board; and
a power supply circuit formed on the circuit board and having:
an input terminal; and
an output terminal connected to the at least one LED;
a light guide mounted on the LED board, being a transparent glass cylinder and having:
a top end;
a bottom end;
an LED chamber formed in the bottom end of the light guide to align with the at least one LED on the LED board;
a pit formed in the top end of the light guide; and
a reflection layer coated on an inner wall of the pit to form a conical reflection mirror on a bottom of the reflection layer, and aligning with the at least one LED on the LED board;
a cover being transparent, having an open bottom end, and corresponding to and mounted on the upper opening of the lamp holder; and
a base mounted on the lower opening of the lamp holder and electrically connected to the input terminal of the power supply circuit on the LED board.

2. The high-efficiency LED lamp as claimed in claim 1, wherein the lamp holder is made from ceramic or aluminum oxide ceramic through a high-temperature sintering process.

3. The high-efficiency LED lamp as claimed in claim 2, wherein the reflection layer is coated on an inner wall of the pit with sputtering aluminum.

4. The high-efficiency LED lamp as claimed in claim 3, wherein the light guide is a glass cylinder made from borosilicate.

5. The high-efficiency LED lamp as claimed in claim 1, wherein the power supply circuit formed on the LED board is an AC power supply circuit having:
a voltage dependent resistor (VDR), wherein one end of the VDR is connected to the base for inputting AC power;
a thermistor, wherein one end of the thermistor is connected to the at least one LED on the LED board, and each one of the at least one LED is an AC LED; and
multiple resistors and a fuse serially connected between the VDR and the thermistor.

6. The high-efficiency LED lamp as claimed in claim 2, wherein the power supply circuit formed on the LED board is an AC power supply circuit having:
a voltage dependent resistor (VDR), wherein one end of the VDR is connected to the base for inputting AC power;
a thermistor, wherein one end of the thermistor is connected to the at least one LED on the LED board, and each one of the at least one LED is an AC LED; and
multiple resistors and a fuse serially connected between the VDR and the thermistor.

7. The high-efficiency LED lamp as claimed in claim 3, wherein the power supply circuit formed on the LED board is an AC power supply circuit having:
a voltage dependent resistor (VDR), wherein one end of the VDR is connected to the base for inputting AC power;
a thermistor, wherein one end of the thermistor is connected to the at least one LED on the LED board, and each one of the at least one LED is an AC LED; and
multiple resistors and a fuse serially connected between the VDR and the thermistor.

8. The high-efficiency LED lamp as claimed in claim 4, wherein the power supply circuit formed on the LED board is an AC power supply circuit having:
a voltage dependent resistor (VDR), wherein one end of the VDR is connected to the base for inputting AC power;
a thermistor, wherein one end of the thermistor is connected to the at least one LED on the LED board, and each one of the at least one LED is an AC LED; and
multiple resistors and a fuse serially connected between the VDR and the thermistor.
